(19) United States
(12) Patent Application Publication
(10) Pub. No.: US 2004/0211946 A1
(43) Pub. Date: Oct. 28, 2004

(54) Padded end cap for vehicle lifting hoist arm

(75) Inventors: Roger A. Farrara, Chico, CA (US); Kenneth E. Jones, Chico, CA (US)

Correspondence Address: WILLIAM W. BODNAR, 818 BROOKWOOD WAY, CHICO, CA, 95926, US

(73) Assignee: Rafken, Inc., Chico, CA

(21) Appl. No.: 10/810,393

(22) Filed: Mar. 25, 2004

Related U.S. Application Data
(60) Provisional application No. 60/458,175, filed on Mar. 26, 2003.

(51) Int. Cl. B66F 7/12

(52) U.S. Cl. 254/90

(57) ABSTRACT

A padded end cap made of resilient material for cushioning the end of lifting hoist arms of automotive lifts. One embodiment of this solid body cushioning apparatus (10) contains a plurality of vertical and horizontal attachment surfaces to affix the apparatus to the substantially square or rectangular end of a vehicle lifting arm. Another solid body embodiment provides at least one concave attachment surface to affix the cushioning apparatus to the substantially cylindrical, circular or semi-circular end of a vehicle lifting arm.

### CROSS REFERENCE TO RELATED APPLICATIONS

This application claims priority from U.S. Provisional Patent Application No. 60/458,175 filed Mar. 26, 2003. The contents of U.S. Provisional Patent Application No. 60/458,175 are fully incorporated herein by reference.

### BACKGROUND OF INVENTION

1. Field of Invention

This present invention relates to automotive lift assemblies, particularly a padded end cap for the end of lifting hoist arms of the automotive lifts.

2. Objects and Advantages

The object of the padded end cap is to provide a surface on the end of the lifting arm that is softer than the composition of the lifting arm.

A further object of the invention is to provide a low-cost, durable device that can be utilized by manufacturers of automotive lift systems as well as commercial operators or home users of new or existing use automotive lifts. This device can be attached to the end of each lifting arm on an automotive lift by any of the means listed hereinafter.

Additional advantages and novel features of the present invention will be set forth in part in the description which follows, and in part will become apparent to those skilled in the art upon examination of the following, or may be learned by practice of the invention. The advantages of the invention may be realized and attained by means of the instrumentalities and combinations particularly pointed out in the appended claims.

### PRIOR ART

Automotive lift systems are well known is the art, particularly in the automotive servicing field, where a technician must often raise a vehicle to a predetermined height above the ground in order to make appropriate repairs. Automotive lift assemblies can be constructed in a variety of configurations but typically have four lifting arms which the vehicle rests on. The lifting arms are extendable to support the vehicle at prescribed load bearing positions.

All automotive lifting arms are made of metal and most are square or rectangular in shape. The ends of the lift arms are also predominately square or rectangular in shape. Some manufacturers however, include a cylindrical attachment at the end of their lifting arms to hold a vehicle support stand.

Regardless of the shape of the lifting arm and/or its end, all commercially available lift arms are comprised of metal. There is no evidence of any device available to attach to the end of the lifting arms to provide a surface softer than metal, i.e., a cushioning surface.

### SUMMARY OF INVENTION

This present invention is a padded end cap for cushioning the end of the lifting arms on automotive lifts. This article of manufacture supplies a low-cost, durable product that can be easily fitted to the end of the lifting arms of an automotive lift system.

### BRIEF DESCRIPTION OF DRAWINGS

The character of the invention, however, may be best understood by reference to one of its structural forms, as illustrated by the accompanying drawings, in which:

FIG. 1 is a perspective view of a padded end cap with a plurality of attachment surfaces for affixing the padded end cap to a lifting arm.

FIG. 2a is a perspective view of a padded end cap offset from the end of a lifting arm.

FIG. 2b is a perspective view of a padded end cap in place on the end of a lifting arm.

FIG. 3a is a perspective view of a two-post automotive lift system with four vehicle-lifting arms.

FIG. 3b is a perspective view of a padded end cap in place on the end of a lifting arm.

FIG. 4 is a perspective view of a cylindrical or semi-circular shaped padded end cap.

FIG. 5a is a perspective view of a cylindrical or semi-circular padded end cap offset from the cylindrical end of a lifting arm.

FIG. 5b is a perspective view of a cylindrical or semi-circular padded end cap affixed to the cylindrical end of a lifting arm.

List of Reference Numerals

The following is a list of reference numerals utilized in the drawings provided.

10 Lifting Arm Padded End Cap

12 Back Attachment Surface of Padded End Cap

14 Bottom Attachment Surface of Padded End Cap

16 Side Attachment Surface of Padded End Cap

18 Lifting Arm

20 Vehicle Support Stand

22 Automotive Lift Support Post

24 Lifting Arm Padded End Cap (Semi-Cylindrical or Semi-Circular)

26 Attachment Surface on Semi-Cylindrical or Semi-Circular Padded End Cap

28 Base for Vehicle Support Stand

### DETAILED DESCRIPTION (OF THE PREFERRED EMBODIMENTS)

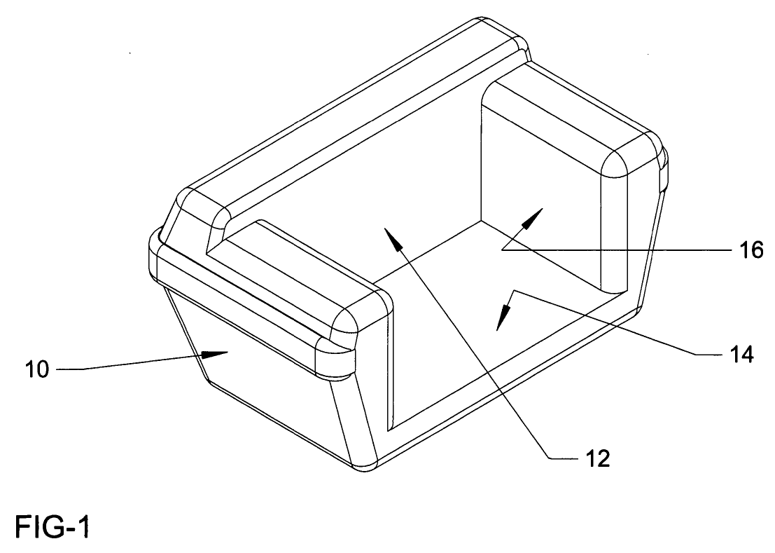

Referring to FIG. 1, which best shows the general features of one embodiment of the invention, a vehicle lifting arm padded end cap (10) is shown with a plurality of attachment surfaces. The one-piece lifting arm padded end cap was produced via a compression molded process utilizing closed cell foam materials. The padded end cap can be produced utilizing any resilient material including, but not limited to, expanded foam, rubber, extruded foam rubber, sponge foam polyurethane foam, integral skin foams, rigid closed cell, integral flexible open cell, expanded polystyrene or compression-molded, closed cell cross-linked polyethylene or other suitable materials. These processes are utilized in manufacturing industries and well known to those skilled in the art.

The FIG. 1 embodiment has a plurality of attachment surfaces for affixing the padded end cap to the end of a lifting arm. Item 12 is a vertical back attachment surface. Item 14 is a horizontal bottom attachment surface. Item 16 is a vertical side attachment surface. There are two opposing vertical attachment surfaces. The configuration of the embodiment shown in FIG. 1 is best suited to fit on the end of a lifting arm that has a square or rectangular shape. The attachment surfaces shown are set against the corresponding end, sides and bottom of a square or rectangular lifting arm.

Padded end caps may be attached to the vehicle lifting arm by, but not limited to, the following means: magnetic, spring clips, Velcro, tie straps, nuts, bolts, screws, snug-fit, slip on, double sided tape, or adhesives.

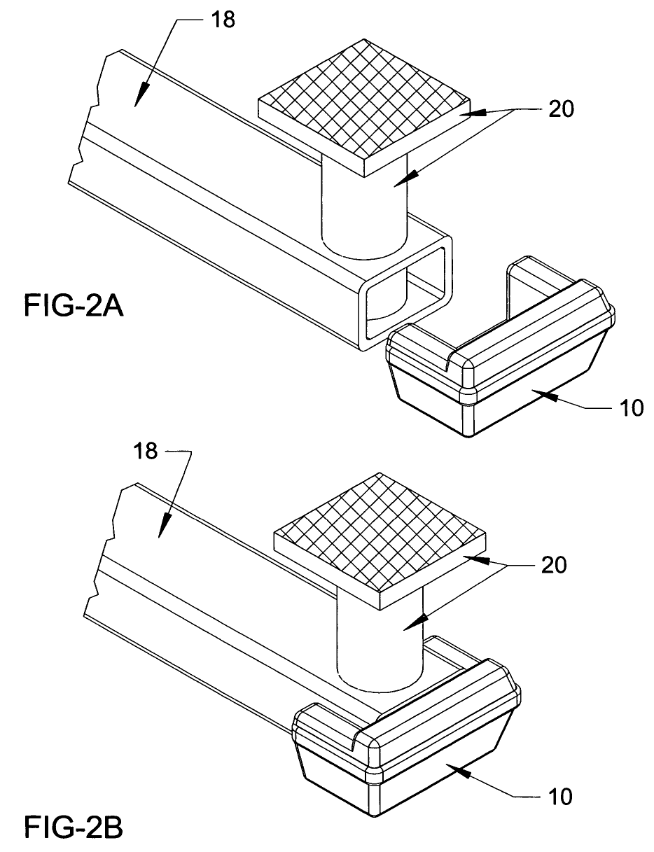

FIG. 2a shows a typical rectangular lifting arm (18) with a vehicle support stand (20). A padded end cap (10) is shown offset from the end of the lifting arm (18).

FIG. 2b shows a typical rectangular lifting arm (18) with a vehicle support stand (20) and an attached padded end cap (10).

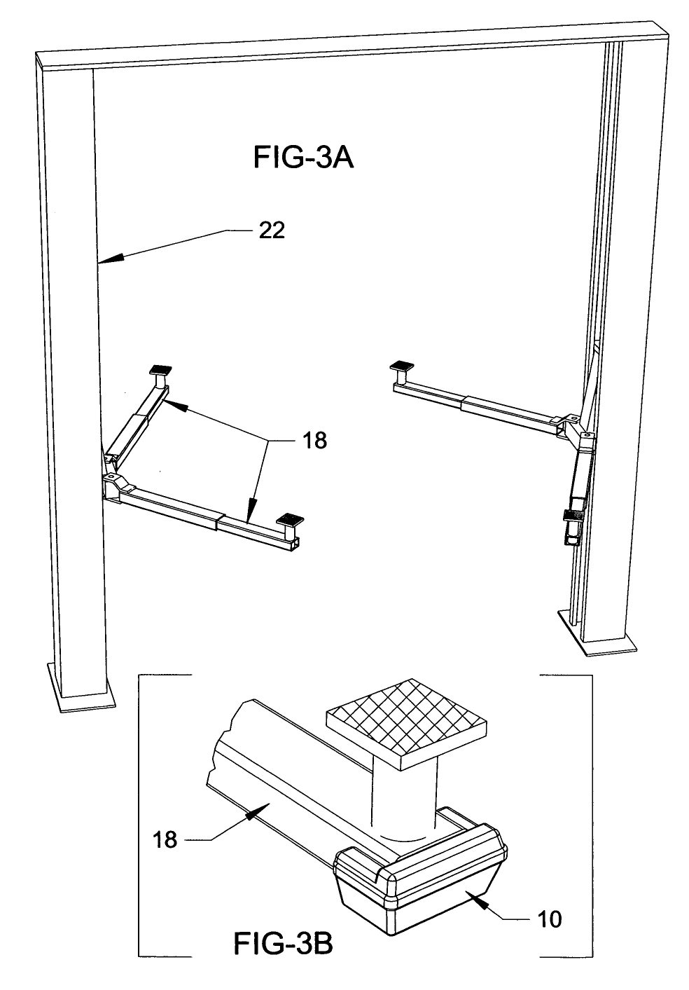

A typical two-post aboveground automotive lift system is shown in FIG. 3a. Two vehicle lifting arms (18) are attached to each support post (22).

FIG. 3b offers a view of a lifting arm (18) with an attached padded end cap (10) in place.

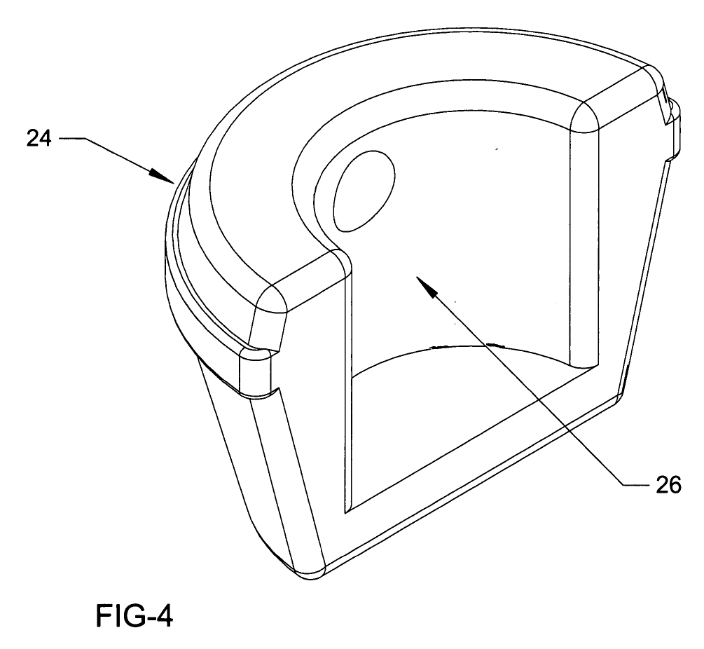

FIG. 4 shows a cylindrical or semi-circular padded end cap (24) with one concave attachment surface (26).

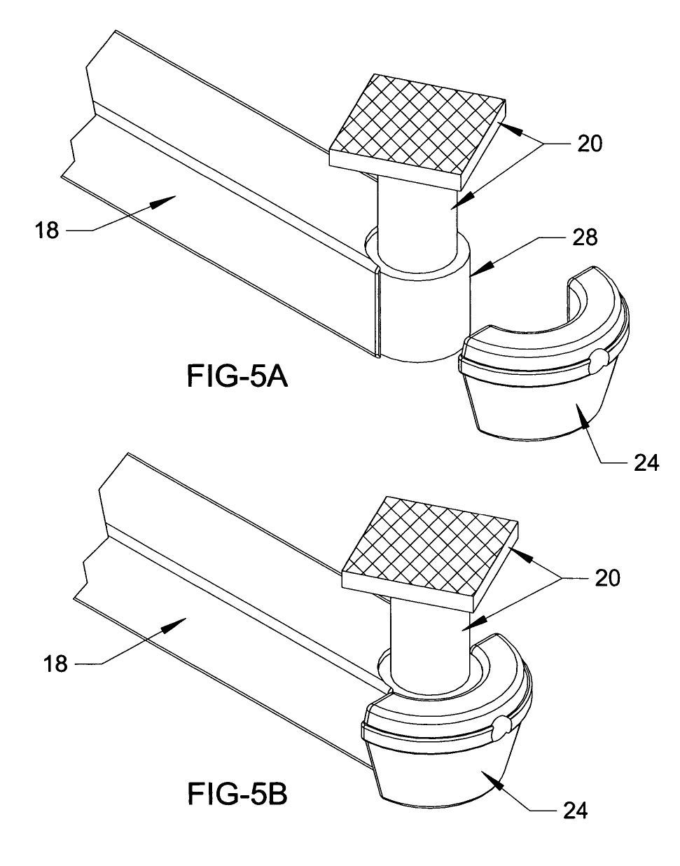

FIG. 5a illustrates a square or rectangular lifting arm (18) with an attached cylindrical base (28) to hold a vehicle support stand (20). Offset from the end of the lifting arm is a cylindrical or semi-circular padded end cap (24).

FIG. 5b shows a square or rectangular lifting arm (18) with an attached cylindrical base (28) to hold a vehicle support stand (20). A semi-cylindrical or semi-circular padded end cap (24) is attached to the cylindrical base.

We claim:

1. In combination:
an automotive lift system lifting arm having a substantially rectangular or square end;
a cushioning apparatus for attaching to the substantially rectangular or square end of the lifting arm, comprising:
a solid body of resilient material having a plurality of exterior surfaces and a front section, two adjacent side sections substantially perpendicular to the front section, and a bottom section substantially perpendicular to the side sections and the front section;
an attachment means for affixing said cushioning apparatus to the substantially rectangular or square end of an automotive lift system lifting arm.

2. A combination according to claim 1 wherein the cushioning apparatus contains indicia disposed on an exterior surface.

3. In combination:
an automotive lift system lifting arm having a substantially cylindrical, circular or semi-circular end;
a cushioning apparatus for attaching to the substantially cylindrical, circular or semi-circular end of the lifting arm comprising:
a solid body of resilient material having a semi-cylindrical or semi-circular shape and at least one concave attachment surface for affixing said cushioning apparatus to the cylindrical, circular or semi-circular end of an automotive lift system lifting arm.
an attachment means for affixing said cushioning apparatus to the cylindrical, circular or semi-circular end of an automotive lift system lifting arm.

4. A combination according to claim 3 wherein the cushioning apparatus contains indicia disposed on an exterior surface.
